(19) United States
(12) Patent Application Publication
(10) Pub. No.: US 2025/0024187 A1
(43) Pub. Date: Jan. 16, 2025

(54) EarBuds Wireless Device and System Thereof

(71) Applicant: Zoreilles Inc, Miramar, FL (US)

(72) Inventors: Irene T. Hyppolite, Davie, FL (US); Serge G. Hyppolite, Davie, FL (US)

(21) Appl. No.: 18/768,184

(22) Filed: Jul. 10, 2024

Related U.S. Application Data
(60) Provisional application No. 63/526,304, filed on Jul. 12, 2023.

(51) Int. Cl. H04R 1/10; H04R 1/02

(52) U.S. Cl. CPC H04R 1/105; H04R 1/025; H04R 1/1025; H04R 2420/07; H04R 2460/13

(57) ABSTRACT

An earbud device, including a top cover, where a printed circuit board, battery, and bone conduction transducer are housed within the top cover, top cover is secured to male bottom cover, male bottom cover is removably engaged with a female bottom cover, where male bottom cover includes at least one charging contact point, and tape secured to female bottom cover. An earbud device system, including at least one earbud device with a bone conduction transducer, where a male bottom cover is removably engaged with a female bottom cover, and tape is removably secured to the female bottom cover, a charging case to electrically charge at least one earbud device, where the charging case has at least one earbud charger bay and at least one charging contact pin; and a storage case, where the at least one female bottom cover with tape is stored within the storage case.

### REFERENCE TO RELATED APPLICATIONS

This patent application claims the benefit under 35 U.S.C. § 119(e) of U.S. Provisional Patent Application No. 63/526,304, filed Jul. 12, 2023, which application is incorporated herein by reference.

### BACKGROUND OF THE INVENTION

Users wear headsets to communicate or to listen to audio transmissions without interrupting other people around them. Current headsets and earphone devices available in the marketplace are not comfortable for the user to wear while in a resting position or during certain activities. For example, while a user lays down to rest with their head resting on a pillow or blanket, existing headsets press into the user's ear and creates a pain and discomfort. Moreover, the headset or earphone devices become dislodged and go farther into the user's ear canal than planned, creating a safety concern.

The size and bulkiness of current headsets do not permit users to lay down comfortably while using their headsets. The headsets routinely fall out of the user's ear, or cause pain to the ear while laying down and pressed inward due to the user's body (e.g., arm or shoulder where the user's head is resting) or a pillow/blanket.

There is a need for a headset device that a user can attach to their body near their ear that does not fall off, so the user does not feel discomfort when lying down. The limitation of having a headset device placed over or within the ear canal is a limiting factor on how a user listens to audio transmissions wirelessly.

As can be derived from the variety of devices and methods directed at connecting wireless headsets to a user, many means have been contemplated to accomplish the desired end, i.e., placing the headset device above or within the user's ear canal. Heretofore, tradeoffs between size and comfort were required. Thus, there is a long-felt need for a headset device that is located in a position that is comfortable for the user while laying down or in other positions. There is a further long-felt need for a headset device that a user can connect to their skin, outside of their ear, using tape with adhesive. There is also a long-felt need for a headset device that a user can connect to the outside of their ear using adhesive tape that uses bone conduction technology to transmit audio to the user's ears.

### BRIEF STATEMENT OF THE INVENTION

The invention broadly relates to wireless headphone devices and a system thereof.

### SUMMARY OF THE INVENTION

The present invention broadly comprises an earbud device, including a top cover, where a printed circuit board, a battery, and a bone conduction transducer are housed within the top cover, the top cover is secured to a male bottom cover, the male bottom cover is removably engaged with a female bottom cover, where the male bottom cover comprises at least one charging contact point, and tape secured to female bottom cover.

It is a general object of the present invention to provide an earbud device system, including at least one earbud device with a bone conduction transducer, where a male bottom cover is removably engaged with a female bottom cover, wherein tape is removably secured to the female bottom cover, a charging case to electrically charge at least one earbud device, where the charging case has at least one earbud charger bay and at least one charging contact pin, and a storage case, where the at least one female bottom cover with tape is stored within the storage case.

It is yet another object of the present invention to provide a method of storing an earbud device, including removing a lower portion the earbud device from an upper portion of the earbud device, storing the lower portion of the earbud device in a storage case, and engaging the upper portion of the earbud device in a charging case.

### OBJECT OF THE INVENTION

It is a general object of the present invention to provide wireless audio transmissions to a user from outside the ear using bone conduction transmissions.

These and other objects and advantages of the present invention will be readily appreciable from the following description of preferred embodiments of the invention and from the accompanying drawings and claims.

### BRIEF DESCRIPTION OF FIGURES

The nature and mode of operation of the present invention will now be more fully described in the following detailed description of the invention taken with the accompanying drawing figures, in which:

FIG. 1 is a front perspective view of a left and right earbud device.

FIG. 2 is a rear perspective view of the left and right earbud devices in FIG. 1.

FIG. 3 is a partially exploded front perspective view of the female bottom cover, tape, and upper portions of the left and right earbud devices of FIG. 1.

FIG. 4 is a partially exploded rear perspective view of the female bottom cover, tape, and upper portions of the left and right earbud devices of FIG. 1.

FIG. 5a is a front perspective view of the upper portions of the left and right earbud devices.

FIG. 5b is an exploded front perspective view of the upper portions of the left and right earbud devices of FIG. 5a.

FIG. 6a is a rear perspective view of the upper portions of the left and right earbud devices.

FIG. 6b is an exploded rear perspective view of the upper portions of the left and right earbud devices of FIG. 6a.

FIG. 7a is a top rear perspective view of the upper portions of the left and right earbud devices.

FIG. 7b is a side view of the upper portions of the left and right earbud devices of FIG. 7a.

FIG. 7c is a cross sectional view of the upper portions of the left and right earbud devices at a cross section location shown in FIG. 7b.

FIG. 8a is a front perspective view of the female twist locks of the left and right earbud devices.

FIG. 8b is a side view of the female twist locks of FIG. 8a.

FIG. 8c is a cross sectional view looking backward of the of the female twist locks of the left and right earbud devices at a cross section location shown in FIG. 8b.

FIG. 8d is a cross sectional view looking forward of the of the female twist locks of the left and right earbud devices at a cross section location shown in FIG. 8b.

FIG. 9a is a side view of a left earbud device positioned in front of a user's ear.

FIG. 9b is a side view of a left earbud device positioned behind a user's ear.

FIG. 10 is a front perspective view of a charging case with a slidable top open and the upper portions of the left and right earbud devices outside of a charging case.

FIG. 11 is a top perspective view of the open charging case and the upper portions of the left and right earbud devices shown in FIG. 10.

FIG. 12 is a front perspective view of the charging case with slidable top in an open position with the upper portions of the left and right earbud device set within the charging case in a charging position.

FIG. 13 is a front perspective view of the charging case with the slidable top closed with the upper portions of the left and right earbud device set within the charging case in a charging position.

FIG. 14 is a top view of the bottom of the charging case and a bottom view of slidable top.

FIG. 15 is a front perspective view of the storage case assembly in an unassembled position with the storage case open and the lower portions of the left and right earbud devices outside of the storage case.

FIG. 16a is a front perspective view of the storage case assembly with the lower portions of the left and right earbud devices stored inside of the storage case with the storage case cover in an open position.

FIG. 16b is a front perspective view of the storage case assembly with the lower portions of the left and right earbud devices stored inside of the storage case with the storage case cover in a closed position.

### DETAILED DESCRIPTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “earbud” is synonymous with terms such as “headphone”, “earpod”, “earphone”, “headset”, etc., and such terms may be used interchangeably as appearing in the specification and claims. Although any methods, devices or materials similar or equivalent to those described herein can be used in the practice or testing of the invention, the preferred methods, devices, and materials are now described.

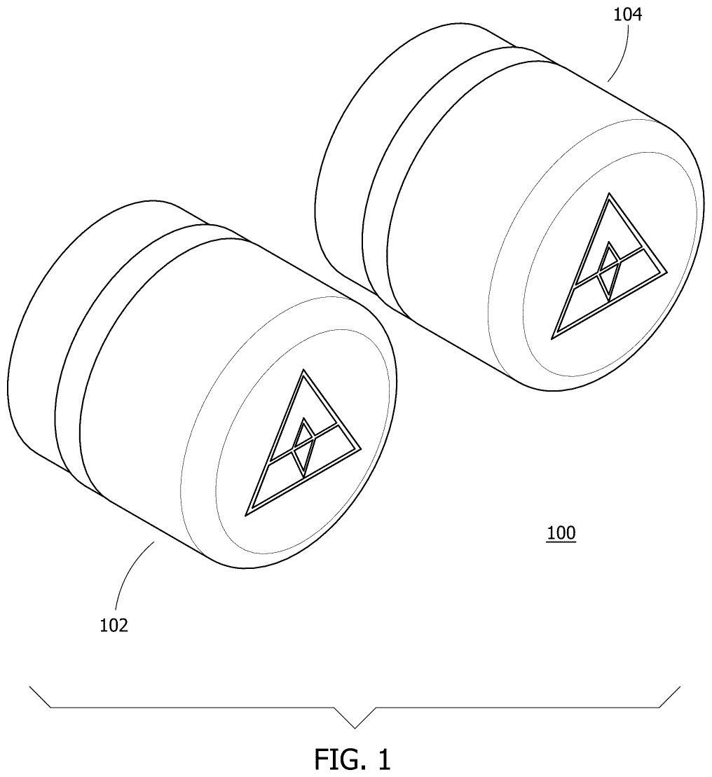

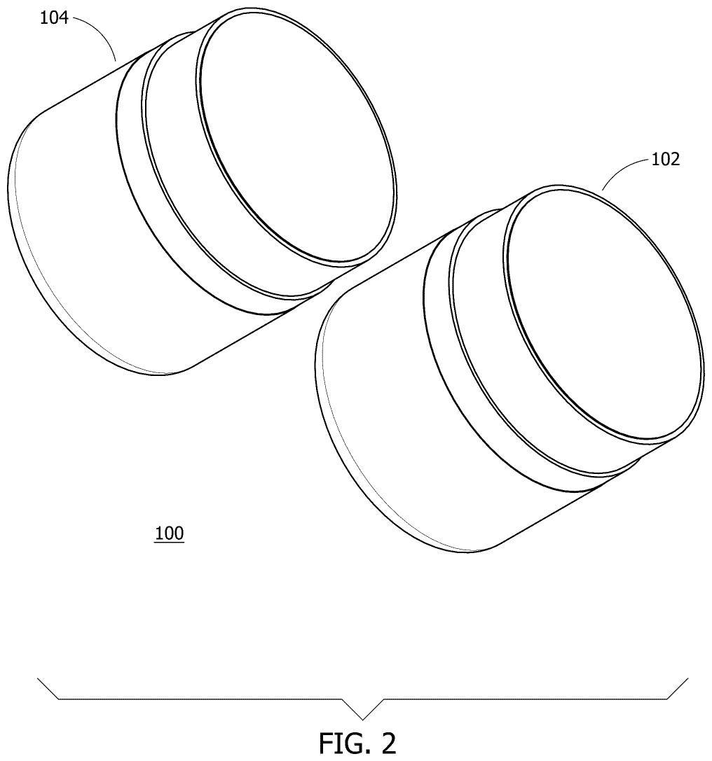

Adverting now to the figures, FIGS. 1-4 show a set of two earbud devices 100 that are wireless. A left earbud device 102 and right earbud device 104 are the standard pairing of earbud devices 100 to set near a person's left ear and/or right ear. An earbud device 100 is designed to be secured next to a user's ear for wireless listening to audio, such as music, e-books, and podcasts. The earbud devices 100 use short-range wireless technology (e.g., BLUETOOTH) to transmit audio transmission from a source (e.g., cell phone, computer) to the ear bud devices 100.

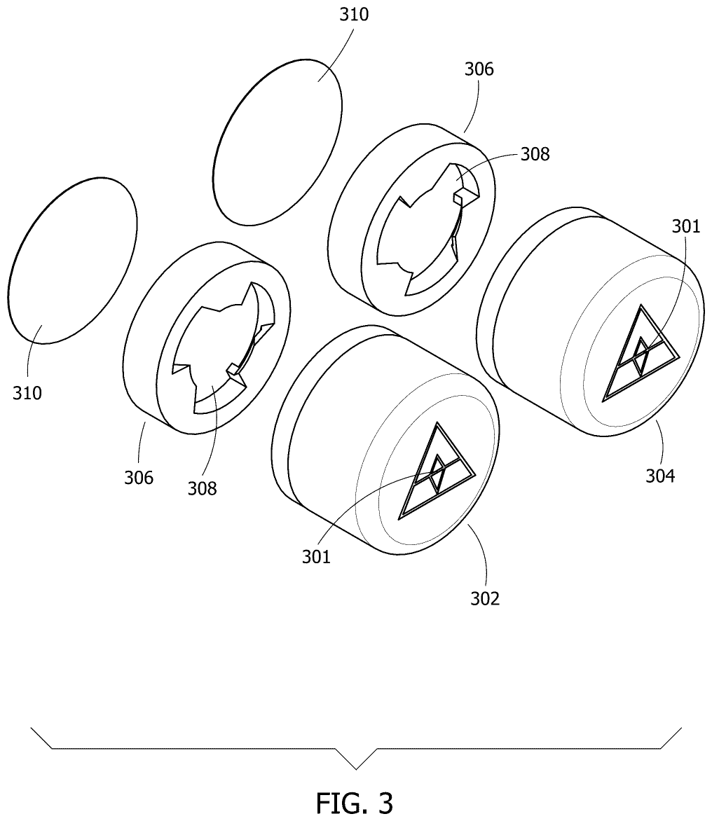

FIG. 3 shows a partially exploded view of left earbud device 102 and right earbud device 104. Left earbud device 102 includes left upper portion 302, female bottom cover 306, female twist lock 308, and tape 310. Right earbud device 104 includes right upper portion 304, female bottom cover 306, female twist lock 308, and tape 310. An optional logo 301 is shown on the top of the earbud devices 100. The logo 301 can be any design or text, such as a company logo or name, or a creative design that is customized by the user.

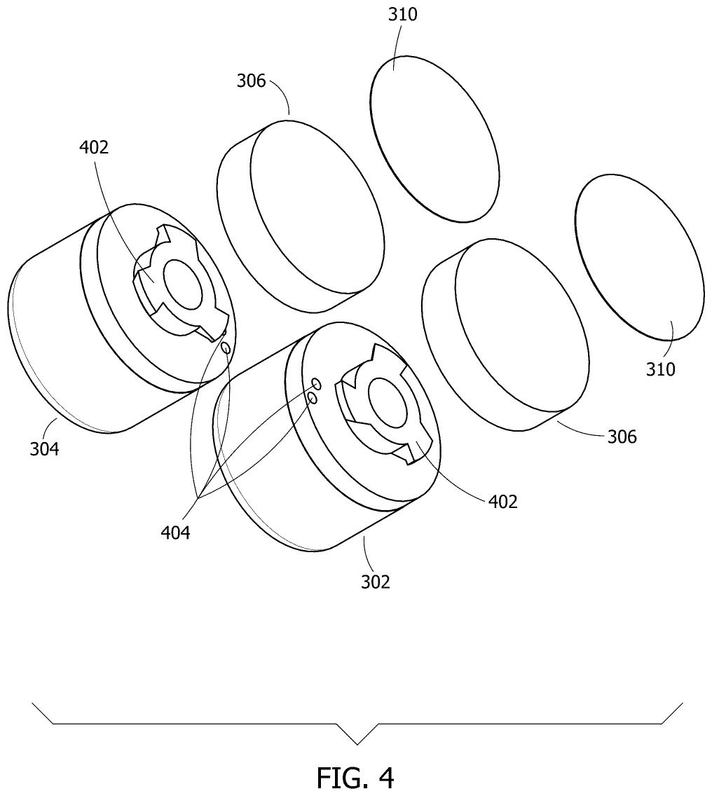

FIG. 4 shows the male twist lock 402 and charging contact points 404. In an exemplary embodiment, each earbud device 100 includes two charging contact points 404. Male twist lock 402 is designed to removably connect to female twist lock 308.

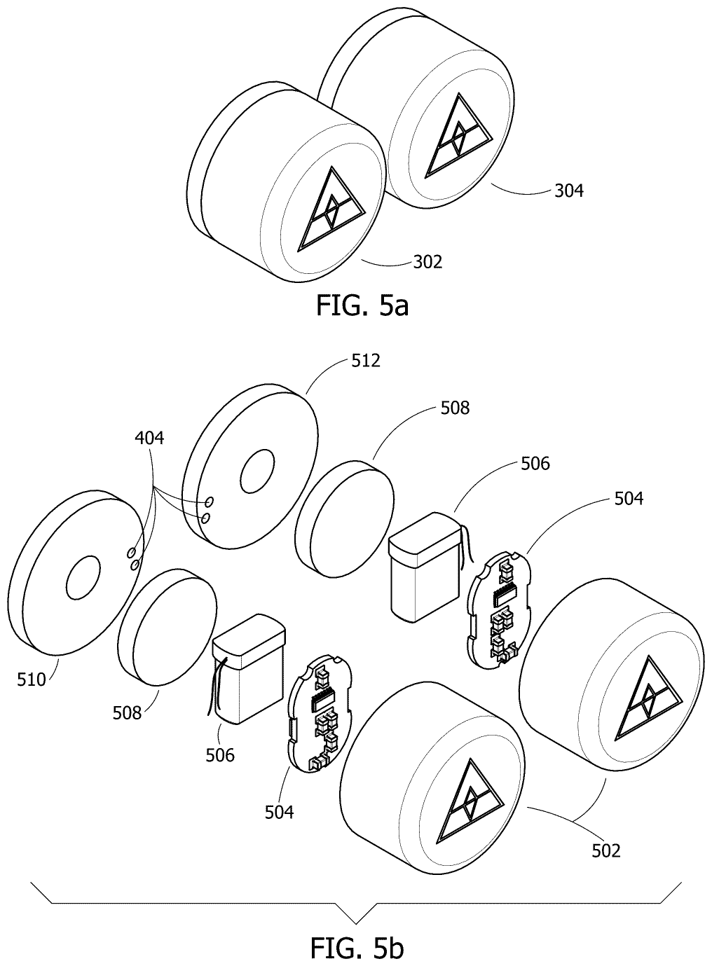

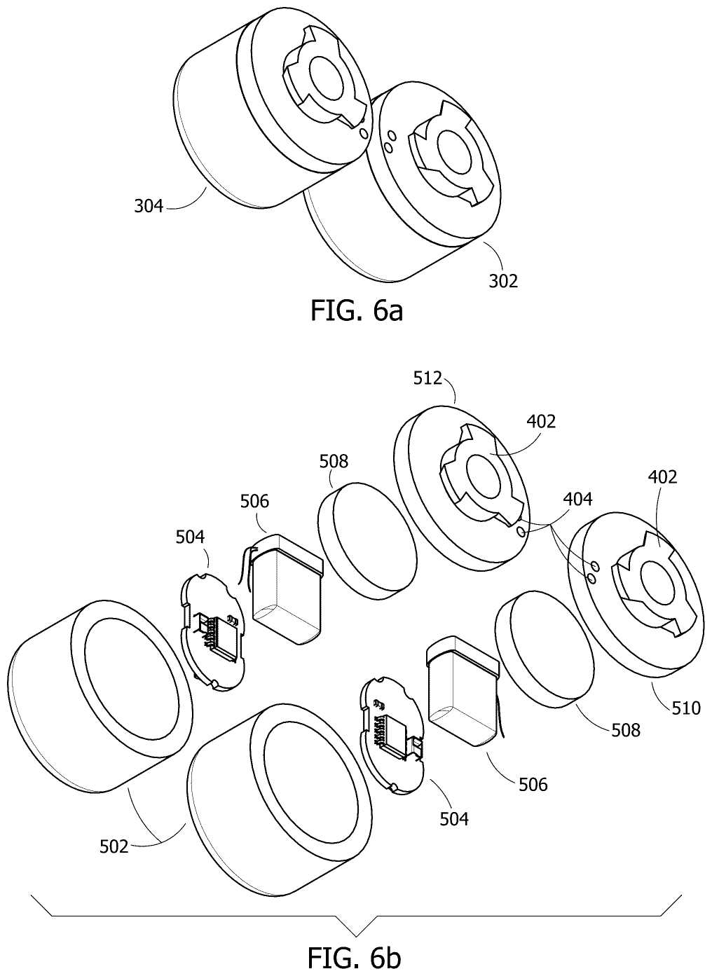

FIGS. 5a and 6a shows left upper portion 302 and right upper portion 304. FIGS. 5b and 6b are an exploded view of left upper portion 302 and right upper portion 304 of left earbud device 102 and right earbud device 104.

Left upper portion 302 and right upper portion 304 each include top cover 502. Housed within top cover 502 are a printed circuit board 504, battery 506, and bone conduction transducer 508. Printed circuit board 504 is secured to battery 506, and battery 506 is secured to bone conduction transducer 508.

Printed circuit board 504 is an electronic wiring board used to connect wire components together in a circuit. For the instant invention, printed circuit boards 504 and bone conduction transducers 508 are electrically powered using batteries 506. In an audio context, a bone conduction transducer 508 (or bone oscillator) sends sound vibrations to the inner ear of a user 902 primarily through the bones in the skull of the user 902. The audio transmission is in the form of sound waves that vibrate the user's 902 bones near their car, as opposed to audio passing through air into the ear canal.

Printed circuit board 504, battery 506, and bone conduction transducer 508 are electrically and physically connected to each other within top cover 502. The components are secured within top cover 502 using an electronics adhesive (or other standard means to secure electronics), which is a durable paste that provides electronic insulation and resists environmental factors. A first top cover 502 is secured to left male bottom cover 510. A second top cover 502 is secured to right male bottom cover 512. Each male bottom cover 510, 512 includes conduction opening 514 within the male twist lock 402 for optimal bone conduction sound output to the user. Conduction opening 514 allows for a greater unobstructed path for the bone conduction sound to travel from the bone conduction transducer 508 through the user 902.

Overall, the components of left upper portion 302 and right upper portion 304 are almost the same. The key difference is the location and orientation of the charging contact points 404 on the flat outer portion of the male bottom covers 510, 512 (see FIGS. 5b and 6b). The location of the two charging contact points 404 on left male bottom cover 510 mirror the location of the two charging contact points 404 on right male bottom cover 512. Aside from the charging contact point 404 locations, the left upper portion 302 of left earbud device 102 has the same components as the right upper portion 304 of right earbud device 104.

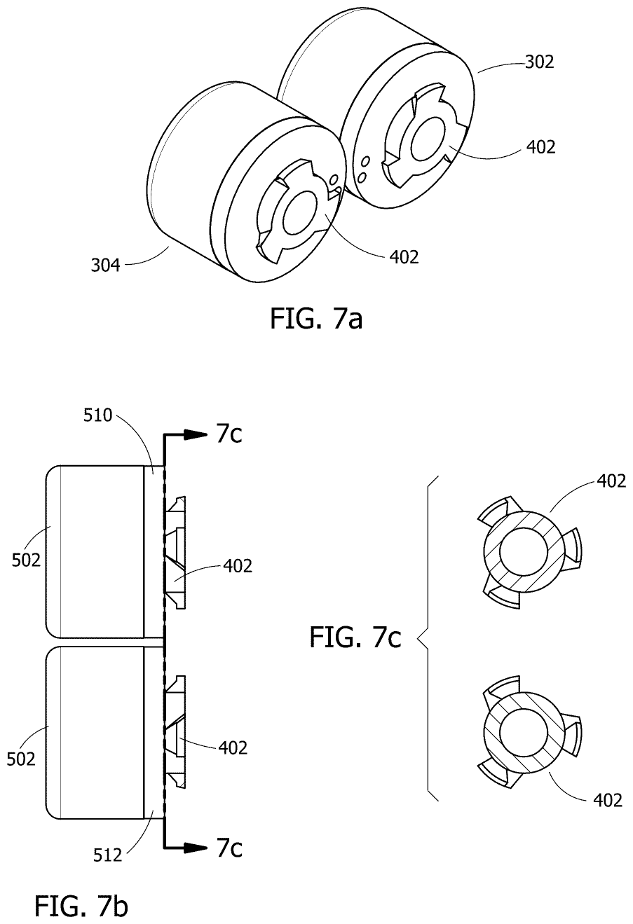

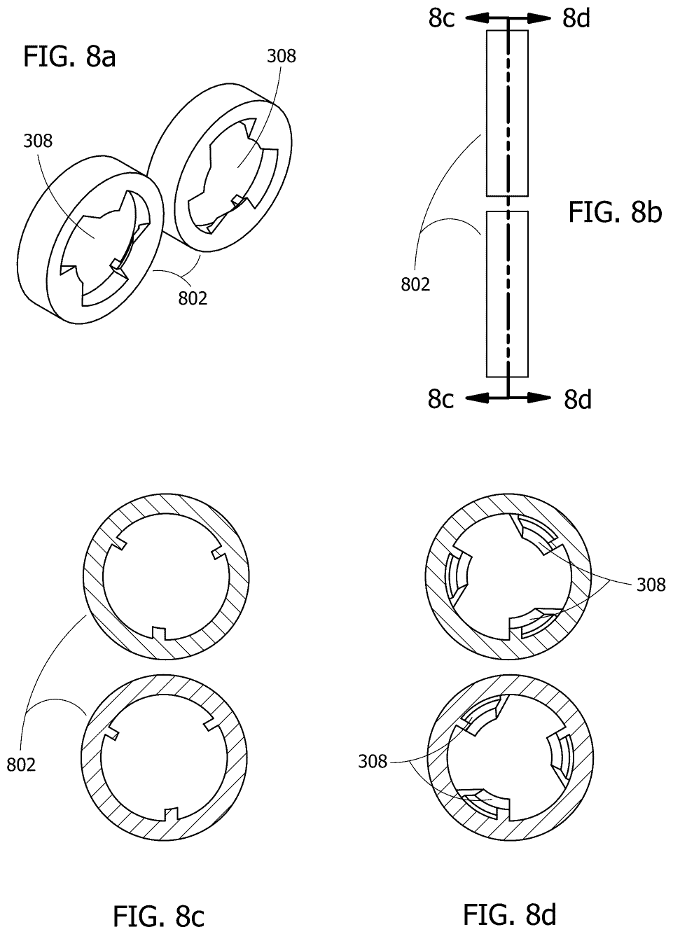

FIGS. 6a, 6b, 7a, 7b, and 7c show male twist lock 402 on the left upper portion 302 and right upper portion 304. Male twist lock 402 engages with female twist lock 308, which is formed within female bottom cover 306 (as shown in FIGS. 8a, 8b, 8c, and 8d). Lower portion 802 includes female bottom cover 306 and tape 310.

Left upper portion 302 is removably engaged with lower portion 802 through the mating of male twist lock 402 and female twist lock 308. Right upper portion 304 is removably engaged with lower portion 802 through the mating of male twist lock 402 and female twist lock 308. When the left upper portion 302 is secured to lower portion 802, the result is left earbud device 102. When the right upper portion 304 is secured to lower portion 802, the result is right earbud device 104.

While male twist lock 402 and female twist lock 308 are preferably utilized in the instant invention to removably secure upper portions 302, 304 to lower portions 802, other removable connections can be used. In an exemplary embodiment, a snap connection is used to connect upper portions 302, 304 to lower portions 802.

As shown in FIGS. 3 and 4, tape 310 is removably secured on the bottom of female bottom cover 306. Tape 310 includes an inner surface and outer surface. An adhesive is located on the inner surface and outer surface of tape 310. While an adhesive is used on the inner surface of tape 310 to secure tape 310 to the bottom of female bottom cover 306, other connection methods can be used to achieve the same result. Examples include hook and loop fasteners, glue, and snaps. The outer surface of tape 310 includes an adhesive that is designed to removably stick to the user's skin.

The purpose of tape 310 is two-fold. First, tape 310 provides a clean environment for the earbud devices 100 to connect to on the user's skin. Second, tape 310 prevents skin discomfort compared to a suction device being directly attached on the skin. Tape 310 is designed to be reusable over multiple uses, depending on the type of use (e.g., exercise or resting) and environmental conditions (e.g., humidity).

In a preferred embodiment, tape 310 is circular in shape and made of a hydrocolloid material (also known as skin contact stickers). Hydrocolloid tape is designed to adhere to a person's skin. Hydrocolloid tape is breathable and biodegradable. In a medical setting, hydrocolloid tape is used to treat uninfected wounds. The use of hydrocolloid tape for the instant invention is designed to minimize adverse impact on a person's skin from the repeated and prolonged use of adhesives on the human skin. While a circular shape tape 310 is preferred, various other shapes can be used to customize the surface area of tape 310 that contacts the user's skin.

Tape 310 is used to keep the earbud devices 100 in place on the user while the user is listening to music or other audio content. Tape 310 secures the earbud devices 100 on the skin near the user's ear. The tape 310 is reused multiple times, meaning that a user can adhere the earbud devices 100 to his/her skin and remove the earbud devices 100 from his/her skin multiple times before the adhesiveness of the tape 310 wears out and loses its adhesive qualities. The tape 310 is designed to maintain adhesion for several days after the initial use. While the plural use of earbud devices 100 is used herein, a user can use a single earbud device 100 (i.e., left earbud device 102 or right earbud device 104) at a time.

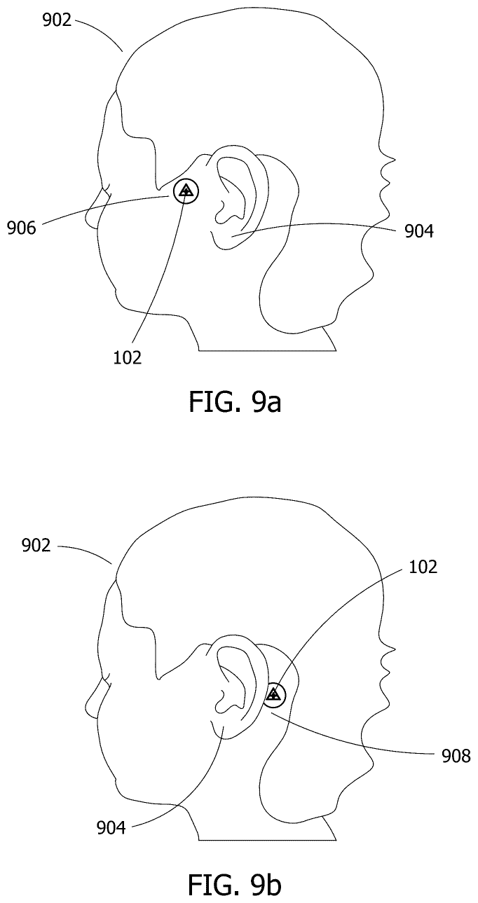

As shown in FIGS. 9a and 9b, earbud devices 102, 104 are used near the user 902's left ear 904. FIG. 9a shows left earbud device 102 secured to the user 902 at Placement A 906, in front of the left ear 904. FIG. 9b shows left earbud device 102 secured to the user 902 at Placement B 908, behind the left ear 904. Similar placement options apply to the user's right ear (not pictured). In an exemplary embodiment, earbud devices 100 are place near the mastoid bone behind the ear or forehead of user 902.

For optimal use, user 902 presses a left earbud device 102 on his/her skin near his/her left car 904, and a right earbud device 104 on his/her skin near his/her right ear (not pictured). While the use of both a left earbud device 102 and right earbud device 104 is preferred for optimal sound quality, users may elect to use a singular left earbud device 102 or right earbud device 104 one at a time. In this situation, the user 902 can leave the upper portion 302, 304 of un-used earbud device 100 in the charging case 1004 (and the corresponding lower portion 802 in the storage case base 1504) so at least one upper portion 302, 304 of an earbud device 100 maintains its charge at all times.

The earbud devices 100 are configured for use for standard listening of music, videos, and similar audio sources. The earbud devices 100 are also compatible for gamers and gaming consoles. The earbud devices 100 connected to the user's skin accelerate the adoption of virtual reality (VR) gaming applications, as the earbud devices 100 provide a comfortable wireless audio device for immersive experiences. The earbud devices 100 also locate the audio source away from the ear cavity, as with standard audio devices, which reduces compatibility issues with VR headsets and allows the user to still hear other audible environmental sources, such as a child crying or emergency calls. The instant invention is also compatible for military applications. Military personnel wearing the headset will still be able to hear important audio communications or announcements, without having their ear(s) blocked by an in-ear headset. This allows the personnel to react faster to their environments, which is often dangerous and fast paced.

The earbud devices 102, 104 are secured to user 902 by placing the outer adhesive of the outer surface of the tape 310 onto the user's 902 skin. Tape 310 is designed to be secured and removed from the user's 902 skin for repeated use. After the tape 310 loses its adhesive qualities and no longer adheres to the user 902, the user 902 replaces tape 310 on female bottom cover 306 with a new piece of tape 310. The frequency of replacement of tape 310 on female bottom cover 306 depends on a variety of environmental factors, such as the nature of the user's skin (e.g., dry or oily), the humidity of the air, and whether the user 902 is using the earbud devices 100 in air conditioning or during exercise.

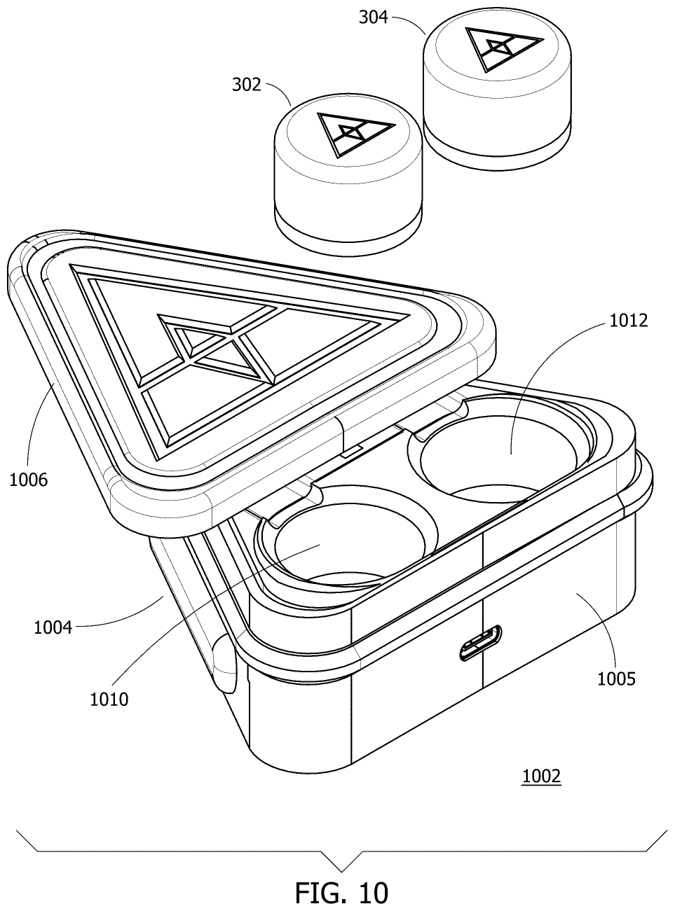

FIG. 10 shows the earbud assembly 1002, which includes two earbud devices 102, 104 and charging case 1004. Charging case 1004 includes a charging case base 1005, slidable top 1006, left earbud charger bay 1010, and right earbud charger bay 1012.

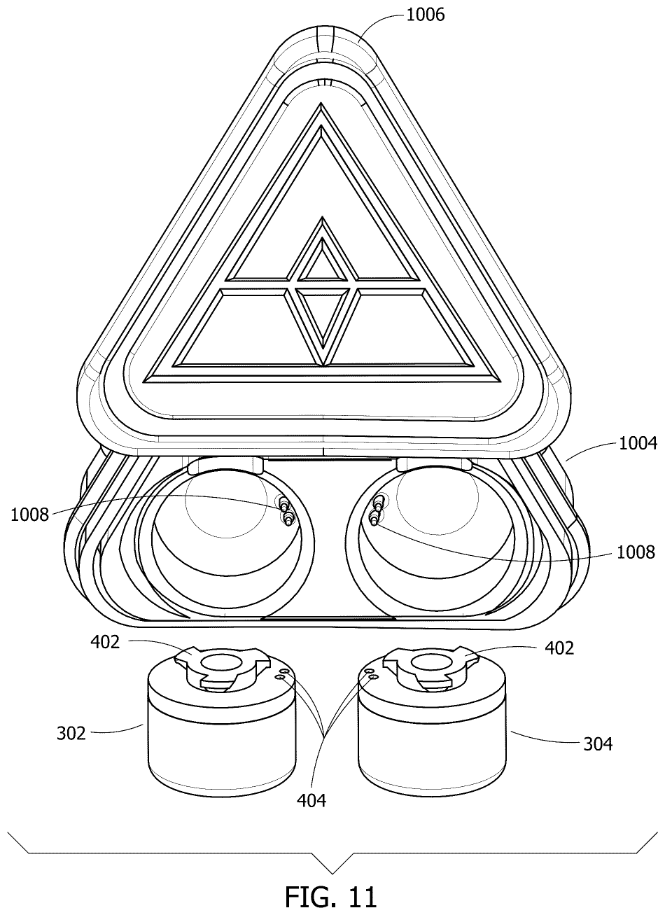

FIG. 11 shows two charging contact pins 1008 located in each earbud charger bay 1010, 1012. The charging contact pins 1008 in left earbud charger bay 1010 are positioned to make contact with charging contact points 404 on left male bottom cover 510. The charging contact pins 1008 in right earbud charger bay 1012 are positioned to make contact with charging contact points 404 on right male bottom cover 512.

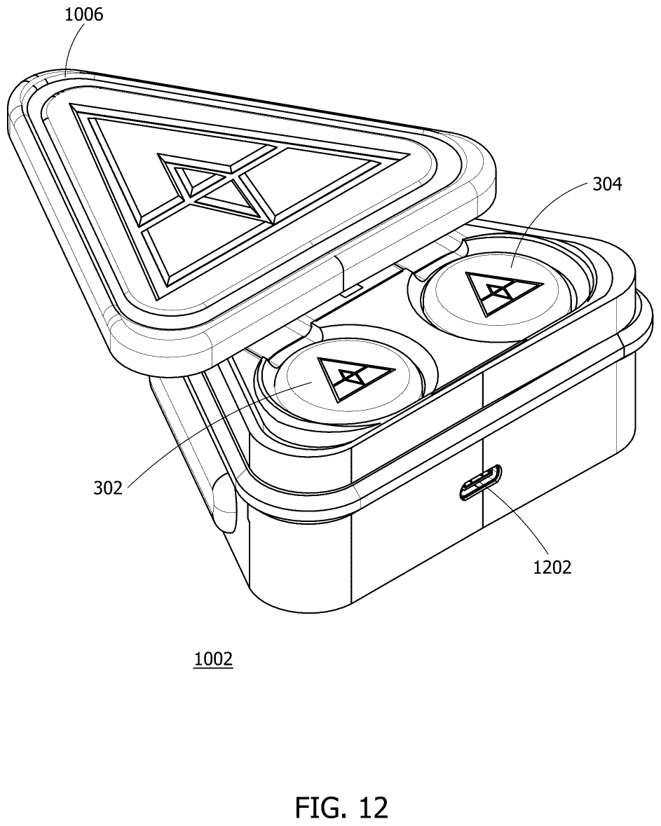

The fully assembled left and right earbud devices 102, 104 will not fit in the charging case 1004. To charge the left and right earbud devices 102, 104, the lower portion 802 of each left/right earbud device 102, 104 is removed (twisted) from upper portions 302, 304. As shown in FIG. 11, left upper portion 302 is positioned within left earbud charger bay 1010. Right upper portion 304 is positioned within right earbud charger bay 1012. When the upper portions 302, 304 are positioned within earbud charger bays 1010, 1012, as shown in FIG. 12, charging contact points 404 come into direct contact with charging contact pins 1008, which enables charging of the upper portions 302, 304 through charging case base 1005.

Charging case 1004 is electrically powered through charging port 1202. In an exemplary embodiment charging port 1202 is a USB-C connection. Electrical power from a standard power source, such as a wall outlet or portable charger, is supplied to charging case base 1005 through charging port 1202. Electrical power is stored within a charging case battery (not pictured) within charging case base 1005. When earbud devices 102, 104 are positioned within earbud charger bays 1010, 1012, the upper portions 302, 304 are charged with electricity.

As shown in FIGS. 10-14, charging case 1004 is triangular in shape. In exemplary embodiments, charging case 1004 is circular or rectangular in shape.

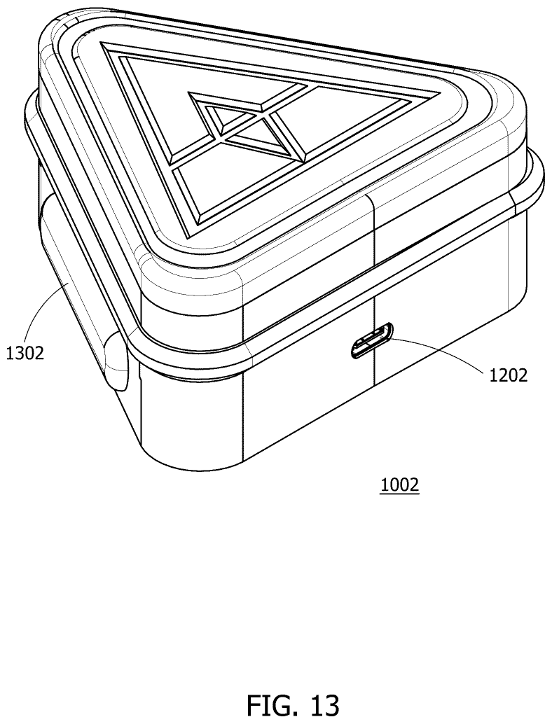

FIG. 13 shows the charging case 1004 in a closed position. Slidable top 1006 is in a closed position relative to charging base case 1005. Slidable top 1006 moves to open and closed positions relative to charging case base 1005 to permit insertion and removal of upper portions 302, 304 from the earbud charger bays 1010, 1012. Upper portions 302, 304 can be charged in charging case 1004 as a set or individually. Upper portions 302, 304 charge in charging case base 1005 when the slidable top is open or closed relative to charging case base 1005.

FIG. 13 shows rubber grips 1302, which are placed on at least one side of the charging case base 1005. In an exemplary embodiment, rubber grips 1302 are placed on two sides of the triangular charging case base 1005 and charging port 1202 is on the remaining third side of the charging case base 1005. Rubber grips 1302 are positioned to assist user 902 in holding charging case 1004 during transit, when opening and closing slidably top 1006, and when depositing upper portions 302, 304 in earbud charger bays 1010, 1012.

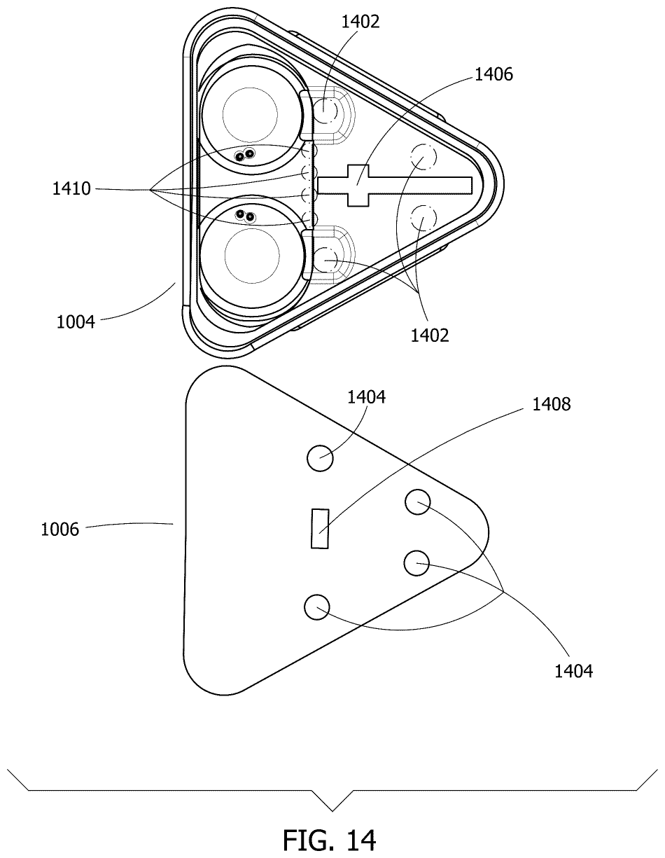

FIG. 14 shows the top of charging case base 1005 and the bottom of slidable top 1006. Base magnets 1402 are located on charging case base 1005 and top magnets 1404 are located on slidable top 1006. The magnets aid in keeping slidable top 1006 closed relative to charging case base 1005 when charging case 1004 is in a closed position. The magnets create a “snap in place” effect to fully seat the slidable top 1006 to charging case base 1005. Keeping charging case 1004 closed also avoids inadvertent opening of the slidable top 1006 and dropping of upper portions 302, 304, and avoids exposure with debris, water, and other environmental contaminants.

A female slidable lock opening 1406 is on the charging case base 1005. A male slot 1408 is located on slidable top 1006 and engages with female slidable lock opening 1406 when the slidable top 1006 is slid open and closed relative to charging case base 1005.

LED indicators 1410 are housed within charging case base 1005. The lights of LED indicators 1410 are viewable from the top of the charging case base 1005 when the applicable LED indicator 140 is illuminated. LED indicators 1410 on the charging case base 1005 informs the user the current charge level/status of the charging case base 1005, whether the charging case base 1005 is being charged, and the charge status of upper portions 302, 304. For example, a green light means the charging case base 1005 and/or the upper portions 302, 304 are fully charged. An orange light means the upper portions 302, 304 are being charged, and a red light means the charging case base 1005 itself needs to be recharged.

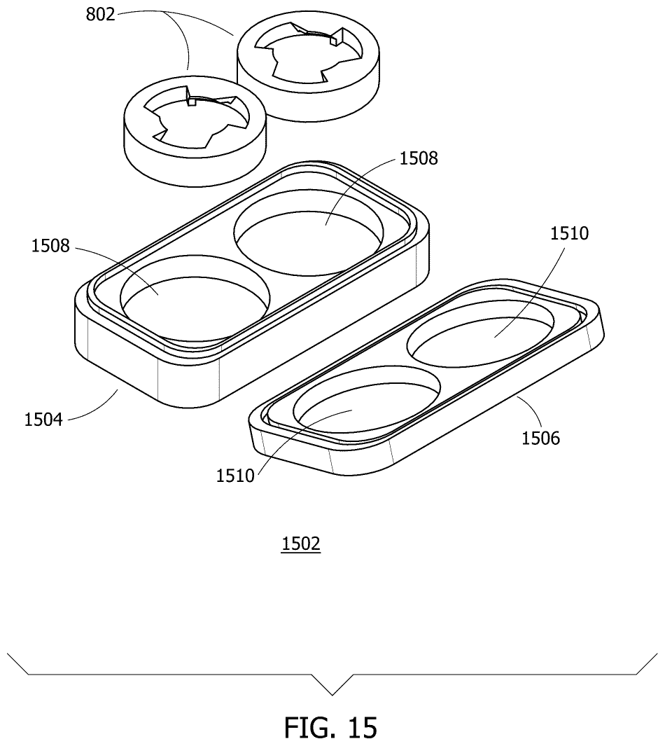

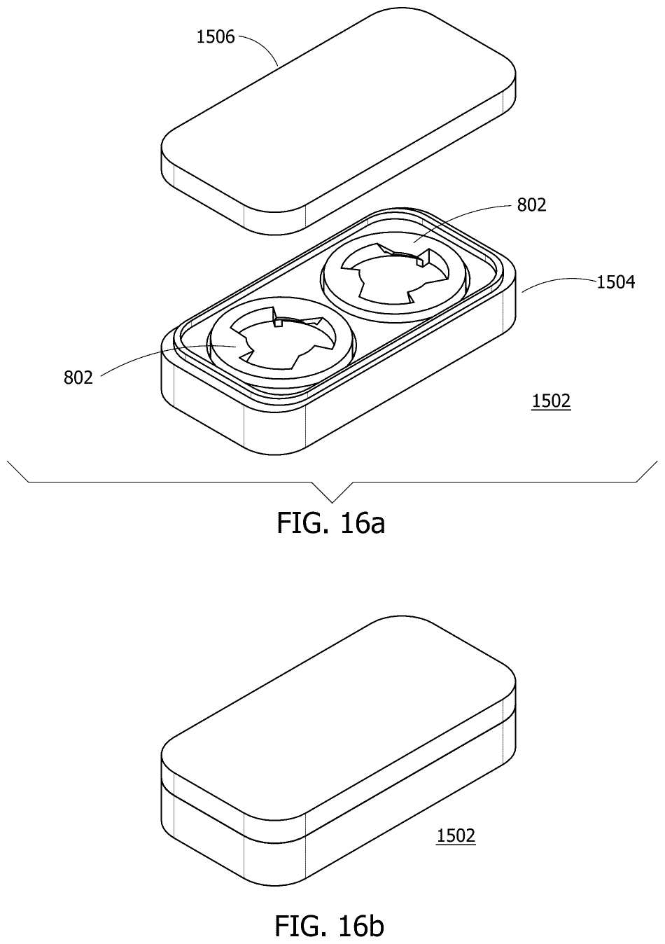

FIGS. 15, 16a, and 16b show storage case assembly 1502. The storage case assembly 1502 includes the storage case base 1504, storage case cover 1506, storage case base bay 1508, and storage case cover bay 1510. When the upper portions 302, 304 are separated from lower portions 802 when upper portions 302, 304 are being charged in charging case base 1005, lower portions 802 are stored in storage case bays 1508 of the storage case base 1504. The lower portions 802, which include female bottom covers 306 and tape 310, are positioned in storage case bays 1508 (as shown in FIG. 16a).

After lower portions 802 are stored within storage case bays 1508, storage case cover 1506 is secured to storage case base 1504. When lower portions 802 are stored within storage case assembly 1502, the tape 310 is kept clean while the lower portions 802 are separated from upper portions 302, 304 and not in use on full assembly earbud devices 100. In an exemplary embodiment, the material of storage case base 1504 does not adhere to tape 310.

To charge the upper portions 302, 304, the lower portions 802 are removed from the upper portions 302, 304. In the instant invention, male twist locks 402 are disengaged from female twist locks 308. Once removed, the lower portions 802 are stored in the storage case assembly 1502. The upper portions 302, 304 are engaged in the charging case base 1005 for charging.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

1. An earbud device, comprising:
a top cover, wherein a printed circuit board, a battery, and a bone conduction transducer are housed within the top cover;
the top cover is secured to a male bottom cover, wherein the male bottom cover comprises at least one charging contact point;
the male bottom cover is removably engaged with a female bottom cover; and
tape is removably secured to female bottom cover.

2. The earbud device recited in claim 1, wherein the tape has an outer adhesive on an outer surface of the tape.

3. The earbud device recited in claim 2, wherein the earbud device is secured to a user by placing the outer adhesive of the outer surface of the tape onto a user's skin.

4. The earbud device recited in claim 1, wherein the printed circuit board is secured to the battery, and the battery is secured to the bone conduction transducer.

5. The earbud device recited in claim 1, wherein the male bottom cover comprises a conduction opening for bone conduction transducer output to the user.

6. The earbud device recited in claim 1, further comprising a storage case for at least one lower portion.

7. The earbud device recited in claim 1, further comprising two earbud devices.

8. The earbud device recited in claim 1, further comprising:
the male bottom cover includes a male twist lock; and
the female bottom cover includes a female twist lock, wherein the male twist lock is removably engaged with the female twist lock.

9. The earbud device recited in claim 8, wherein the male bottom cover comprises a conduction opening within the male twist lock for bone conduction transducer output to the user.

10. An earbud device system, comprising:
at least one earbud device with a bone conduction transducer, wherein:
a male bottom cover with at least one charging contact point is removably engaged with a female bottom cover; and
tape is removably secured to the female bottom cover;
a charging case to electrically charge an upper portion of at least one earbud device, wherein the charging case has at least one earbud charger bay and at least one charging contact pin; and
a storage case, wherein the at least one female bottom cover with tape is stored within the storage case.

11. The earbud system recited in claim 10, wherein the at least one earbud device further comprises:
a top cover, wherein a printed circuit board, a battery, and the bone conduction transducer are housed within the top cover;
the top cover is secured to the male bottom cover; and
a male twist lock on the male bottom cover is removably engaged with a female twist lock on the female bottom cover.

12. The earbud system recited in claim 11, wherein:
the upper portion of the at least one earbud device includes the top cover, the male bottom cover, a printed circuit board, a battery, and the bone conduction transducer;
a lower portion of the earbud device comprises the female bottom cover and tape;
the female bottom cover is removed from the male bottom cover; and
the upper portion is inserted into the charging case.

13. The earbud system recited in claim 12, wherein at least one charging contact point on the male bottom cover connects to at least one charging contact pin on the charging case.

14. The earbud system recited in claim 11, further comprising a slidable top connected to a charging case base on the charging case.

15. The earbud system recited in claim 14, wherein the slidable top is magnetically secured to the charging case base.

16. A method of storing at least one earbud device, comprising:
removing a lower portion the at least one earbud device from an upper portion of the at least one earbud device;
storing the lower portion of the at least one earbud device in a storage case; and
engaging the upper portion of the at least one earbud device in a charging case.

17. The method recited in claim 16, wherein the lower portion includes the female bottom cover and tape.

18. The method recited in claim 16, wherein the lower portion the at least one earbud device is removed from the upper portion of the at least one earbud device using a male twist lock on the upper portion and a female twist lock on the lower portion.

19. The method recited in claim 17, wherein the tape has adhesive on the outer surface of the tape.

20. The method recited in claim 18, further comprising pressing the tape of the at least one earbud device on a user's skin.
